(19) United States
(12) Patent Application Publication
(10) Pub. No.: US 2024/0382370 A1
(43) Pub. Date: Nov. 21, 2024

(54) MASSAGE CLAMP

(71) Applicant: Tsung-Hsun YANG, Taichung City (TW)

(72) Inventor: Tsung-Hsun YANG, Taichung City (TW)

(21) Appl. No.: 18/317,320

(22) Filed: May 15, 2023

(51) Int. Cl. A61H 7/00

(52) U.S. Cl. CPC A61H 7/003; A61H 7/001; A61H 2201/1676; A61H 2209/00

(57) ABSTRACT

A massage clamp includes a first clamping member and a second clamping member. The first clamping member has a first pressing portions and a first clamping portion. The second clamping member has a second pressing portion and a second clamping portion. The second pressing portion and the first pressing portion cooperatively define a surrounding space. The second and first clamping portions cooperatively define a clamping opening. The clamping opening is located in the surrounding space.

### FIELD

The present disclosure relates to a massage apparatus, and more particularly to a massage clamp for manual massage.

### BACKGROUND

A fascia is a layer of dense connective tissue that wraps around muscle, blood vessels, and nerves. Massage is an act of using the hand to press against the muscle so as to apply pressure to the fascia, so that tension of the pressed fascia may increase, thereby relaxing the muscle and improving circulation.

Manual massage tools on the market are used to emulate hand massage (e.g., pressing, rubbing, etc.). The manual massage tools are popular since they do not require electric power. However, the aforesaid manual massage tools generally can only be used to push the fascia, but not to pull the fascia, so effect of the massage is limited.

### SUMMARY

Therefore, an object of the disclosure is to provide a massage clamp that can alleviate the drawback of the prior art.

According to the disclosure, the massage clamp includes a first clamping member and a second clamping member. The first clamping member has a first pivot portion, a first connecting portion that extends from the first pivot portion, a first pressing portion that extends from the first connecting portion, and a first clamping portion that extends from the first connecting portion. The second clamping member is pivotally connected to the first clamping member, and is pivotable relative to the first clamping member. The second clamping member has a second pivot portion that is pivotally connected to the first pivot portion, a second connecting portion that extends from the second pivot portion, a second pressing portion that extends from the second connecting portion, and a second clamping portion that extends from the second connecting portion. The second pressing portion and the first pressing portion cooperatively define a surrounding space. The second and first clamping portions cooperatively define a clamping opening. The clamping opening is located in the surrounding space. The first connecting portion, the first pressing portion, and the first clamping portion cooperatively form a Y-shape. The second connecting portion, the second pressing portion, and the second clamping portion cooperatively form a Y-shape. The first clamping portion has a first inner surface that extends to the first connecting portion. The second clamping portion has a second inner surface that extends to the second connecting portion.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view illustrating an embodiment of the massage clamp according to the disclosure.

FIG. 2 is an exploded perspective view of the embodiment.

FIG. 3 is a side view of the embodiment.

FIG. 4 is a side of a first clamping member of the embodiment.

FIG. 5 is a sectional view taken along line V-V in FIG. 3.

FIG. 6 is a perspective view illustrating the massage clamp used to massage the thigh.

FIG. 7 is a side view illustrating the massage clamp used to massage the shoulder.

FIG. 8 is a perspective view illustrating the massage clamp used to massage the calf.

FIG. 9 is a perspective view illustrating the massage clamp used to massage the neck.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

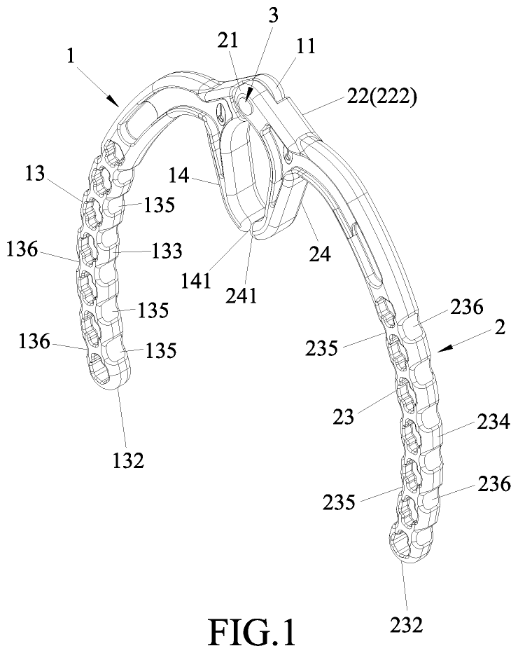

Referring to FIGS. 1 to 3, an embodiment of the massage clamp according to the present disclosure is adapted for massaging the human body. The massage clamp includes a first clamping member 1, a second clamping member 2, and a pivot rod 3 pivotally connected the first and second clamping members 1, 2.

The first clamping member 1 is a one-piece component, and has a first pivot portion 11, a first connecting portion 12 extending from the first pivot portion 11, a first pressing portion 13 extending from the first connecting portion 12 in a direction different from the extending direction of the first connecting portion 12, and a first clamping portion 14 extending from the first connecting portion 12 in a direction different from that of the first pressing portion 13. The first connecting portion 12, the first pressing portion 13, and the first clamping portion 14 cooperatively form a Y-shape. The first pivot portion 11 is for the pivot rod 3 to extend therethrough. Defining a baseline (BL) parallel to a first direction (X) and extending through the pivot rod 3, the first pressing portion 13 and the first clamping portion 14 are located on the same side of the baseline (BL).

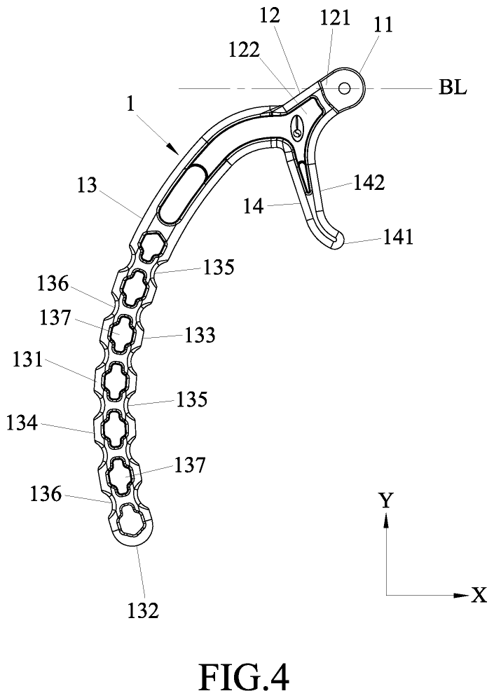

Referring to FIGS. 1, 2, and 4, the first connecting portion 12 extends from the first pivot portion 11. The first connecting portion 12 has a first concave region 121 connected to the first pivot portion 11, and a first convex region 122 connected to the first concave region 121 and protruding relative to the first concave region 121.

The first pressing portion 13 is bent, and extends from the first convex region 122 of the first connecting portion 12 in a direction different from the extending direction of the first connecting portion 12. The first pressing portion 13 includes a first middle section 131 connected to the first connecting portion 12. The first pressing portion 13 terminates at a first free end 132 distal from the first connecting portion 12. The first middle section 131 has a first concave surface 133 recessed outwardly, and a first convex surface 134 opposite to the first concave surface 133 and protruding outwardly. The first concave surface 133 and the first convex surface 134 are formed with a plurality of spaced-apart first finger grooves 135, 136. The recess direction of the first finger grooves 135 formed in the first concave surface 133 is opposite to the recess direction of the first finger grooves 136 formed in the first convex surface 134. The first finger grooves 135, 136 may accommodate a user's fingers, provide an anti-slip effect, and facilitate application of forces. In other modifications, the first concave surface 133 and the first convex surface 134 may not be formed with the first finger grooves 135, 136, and/or may be provided with other anti-slip means such as anti-slip plates or anti-slip strips.

The first clamping portion 14 extends from the first convex region 122 of the first connecting portion 12 in a direction different from that of the first pressing portion 13, and terminates at a first distal end 141. The first clamping portion 14 has a first inner surface 142. The first inner surface 142 extends to the first connecting portion 12, and is directly connected to the first connecting portion 12.

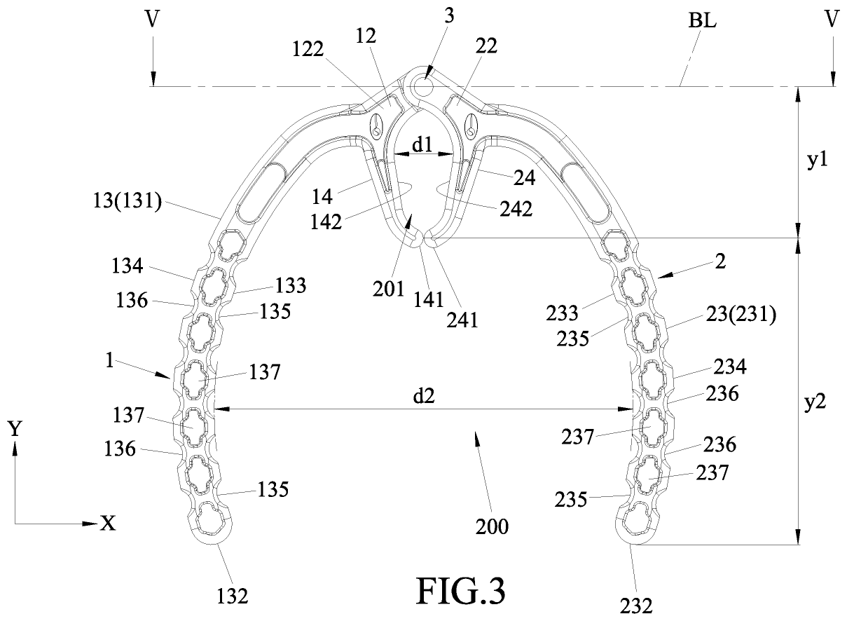

Referring to FIG. 3, y1 is a distance between the first distal end 141 of the first clamping portion 14 and the center of the pivot rod 3 in a second direction (Y) that is substantially perpendicular to the first direction (X). A distance between the first free end 132 and the first distal end 141 in the second direction (Y) is y2. In this embodiment, y2>y1. By virtue of this geometrical design, the distance between the first distal end 141 and the first free end 132 is relatively long, so length of the lever arm is also relatively long, thereby saving manual labor, In addition, the massage clamp has a space in the second direction (Y) sufficient for the user's hand to enter thereinto.

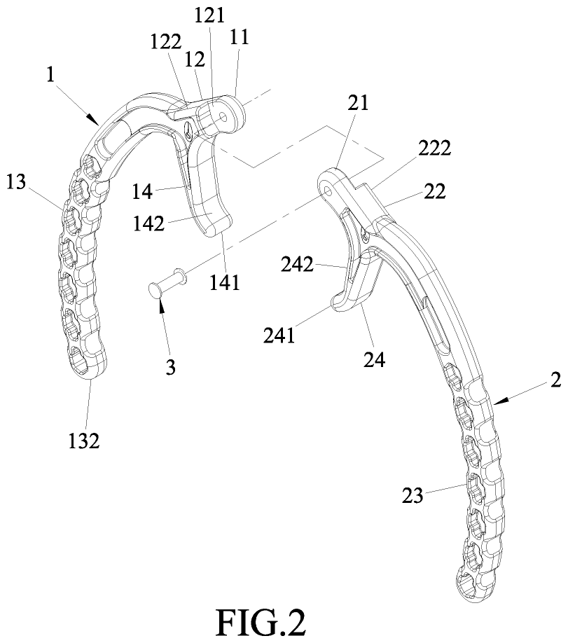

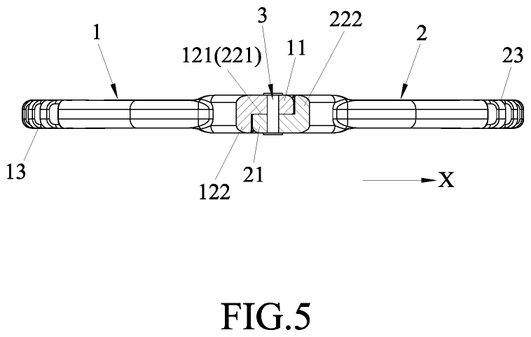

Referring to FIGS. 2, 3 and 5, the second clamping member 2 is pivoted to the first clamping member 1, and is pivotable relative to the first clamping member 1. The first and second clamping members 1, 2 are generally located on the same side of the base line BL. The massage clamp according to this disclosure saves manual labor as resistance (i.e., the first distal end 141 of the first clamping portion 14) exists between the fulcrum (i.e., the pivot rod 3) and the effort (i.e., the first middle section 131 of the first pressing portion 13).

The second clamping member 2 is a one-piece component, and has a second pivot portion 21 disposed adjacent to the first pivot portion 11 and permitting the pivot rod 3 to extend therethrough, a second connecting portion 22 extending from the second pivot portion 21, a second pressing portion 23 extending from the second connecting portion 22 in a direction different from the extending direction of the second connecting portion 22, and a second clamping portion 24 extending from the second connecting portion 22 in a direction different from that of the second pressing portion 23. The second connecting portion 22, the second pressing portion 23, and the second clamping portion 24 cooperatively form a Y-shape. The second connecting portion 22 has a second concave region 221 connected to the second pivot portion 21 and facing the first concave region 121 of the first connecting portion 12, and a second convex region 222 connected to the second concave region 221 and protruding oppositely of the first convex region 122. The second concave region 221 and the first concave region 121 are stacked on each other.

The second pressing portion 23 has a second middle section 231 connected to the second connecting portion 22, and terminates at a second free end 232. The second middle section 231 has a second concave surface 233 recessed outwardly, and a second convex surface 234 opposite to the second concave surface 233 and protruding outwardly. The second and first concave surfaces 233, 133 face each other. The second concave surface 233 and the second convex surface 234 are formed with a plurality of spaced-apart second finger grooves 235, 236. The recess direction of the second finger grooves 235 formed in the second concave surface 233 is opposite to the recess direction of the second finger grooves 236 formed in the second convex surface 234. The second finger grooves 235, 236 may accommodate the user's fingers, provide an anti-slip effect, and facilitate the application of force. In other modifications, the second concave surface 233 and the second convex surface 234 may not be formed with the second finger grooves 235, 236, and/or may be provided with other anti-slip means such as anti-slip plates or anti-slip strips.

The second clamping portion 24 extends from the second connecting portion 22 in a direction different from that of the second pressing portion 23, and terminates at a second distal end 241. When the first pressing portion 13 and the second pressing portion 23 are operated to move toward each other in the first direction (X), the second distal end 241 and the first distal end 141 move toward each other. The second clamping portion 24 has a second inner surface 242 that extends to the second connecting portion 22 and that is directly connected to the second connecting portion 22. The second inner surface 242 and the first inner surface 142 face each other.

The second pressing portion 23 of the second clamping member 2 and the first pressing portion 13 of the first clamping member 1 cooperatively define a surrounding space 200. The second clamping portion 24 and the first clamping portion 14 cooperatively define a clamping opening 201 which is located within the surrounding space 200. As a result of the application of force to the first and second clamping members 1, 2 to pivot the first and second clamping members 1, 2 relative to each other, the first and second clamping portions 14, 24 may be spread apart or closed together so as to press and pull the muscle and fascia.

The pivot rod 3 of the present embodiment is generally higher than the first connecting portion 12 and the second connecting portion 22 in the second direction (Y), so that the pivot angle of the first pivot portion 11 and the second pivot portion 21 may be relatively large, thereby enlarging an opening degree of the clamping opening 201, so that the present embodiment may clamp large muscle groups.

As shown in FIG. 3, the maximum width of the clamping opening 201 in the first direction (X) is d1, and the maximum distance of the surrounding space 200 in the first direction (X) is d2 which is several times greater than d1. Through this geometrical design, the embodiment has sufficient space so that the second pressing portion 23 of the second clamping member 2 and the first pressing portion 13 of the first clamping member 1 may be respectively placed on two opposite sides of a massage region, and is suitable for big muscle groups.

The first and second clamping members 1, 2 of the present embodiment are substantially symmetrical (except the first and second pivot portions 11, 21 and the first and second connecting portions 12, 22). That is to say, the first and second concave surfaces 133, 233 mirror each other, and the first and second inner surfaces 142, 242 mirror each other. Accordingly, the aforesaid geometrical limitations of the first clamping member 1 are also applicable to the second clamping member 2. For the sake of brevity and ease of understanding in the specification, the geometrical limitations of the second clamping member 2 will not be described herein.

In one embodiment, the first pressing portion 13 of this embodiment further has a plurality of spaced-apart first blind holes 137, and the second pressing portion 23 further has a plurality of spaced-apart second blind holes 237. As such, materials needed for the massage clamp may be reduced and a total weight of the massage clamp may be lightened, thereby becoming lightweight. However, in other modification, the first pressing portion 13 and the second pressing portion 23 may not be formed with the first blind holes 137 and the second blind holes 237.

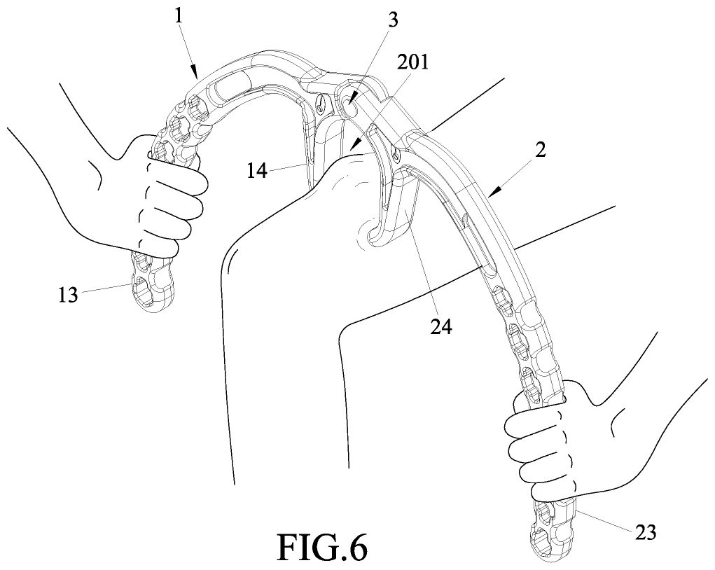

As shown in FIG. 6, when the massage clamp is used to massage the thigh muscle, as long as the clamping opening 201 is moved above the thigh, and the first pressing portion 13 and the second pressing portion 23 are respectively placed on left and right sides of the thigh, forces may be applied to the first pressing portion 13 and the second pressing portion 23, so that the first clamping portion 14 and the second clamping portion 24 may clamp the thigh muscle so as to emulate actions including pushing, pinching, kneading, and pressing, and to pull the thigh muscle by moving the massage clamp upwardly, thereby enhancing the massaging effect.

It should be noted that, since the user may grip the first pressing portion 13 and the second pressing portion 23 with both hands to increase the massaging force, the massage clamp according to the disclosure delivers a good massaging effect. In addition, when operating the massage clamp, the hands are placed on both sides of the user, so that during the massaging process, the elbow does not need to be reversed or excessively raised, which is good in terms of ergonomics, so that fatigue from operating the massage clamp is minimized even after long-term use.

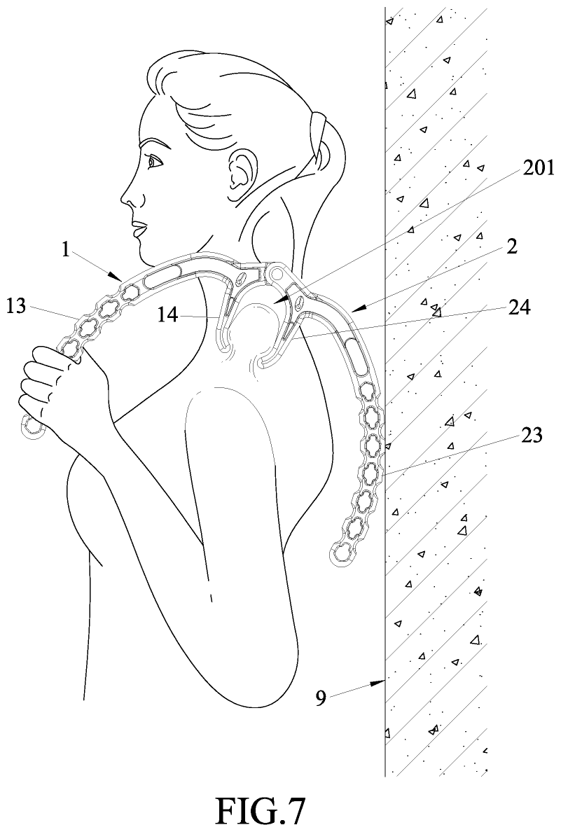

As shown in FIG. 7, when the present embodiment is used to massage the shoulder, after moving the clamping opening 201 to the top of the shoulder and placing the first pressing portion 13 and the second pressing portion 23 respectively on front and rear sides of the shoulder, the user may rest his back against a wall surface 9, so that the second clamping member 2 may abut against the wall surface 9. Then, the first clamping member 1 is held with one hand, so that the first clamping portion 14 and the second clamping portion 24 may clamp the shoulder muscle to massage the muscle. The shoulder muscle may be pulled upwardly by moving the massage clamp upwardly, thereby enhancing the massaging effect. In this manner of use in combination with an abutting wall, a convenient one-handed operation may be realized.

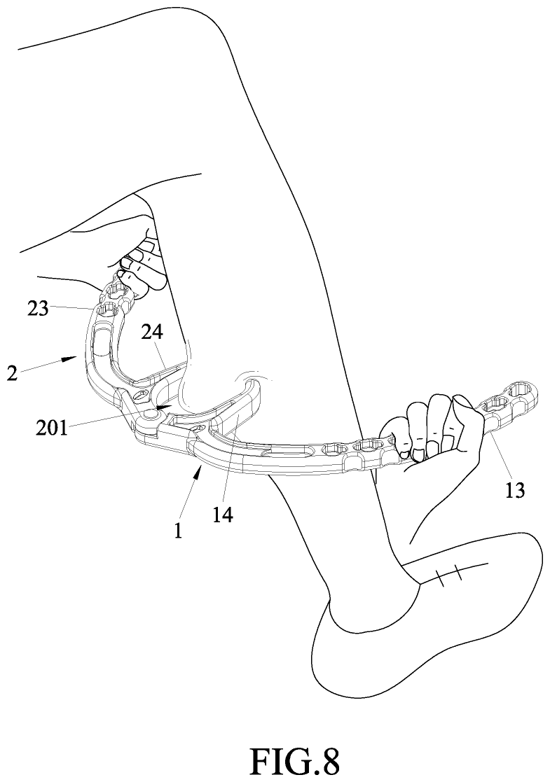

With further reference to FIG. 8, when this embodiment is used to massage the calf, after placing the clamping opening 201 behind the calf and facing towards the calf muscles, and placing the first pressing portion 13 and the second pressing portion 23 respectively on left and right sides of the calf, forces are applied to the first pressing portion 13 and the second pressing portion 23 so as to drive the first and second clamping portions 14, 24 to massage the calf muscles. The calf muscles may be pulled rearwardly by moving the massage clamp rearwardly to enhance the massaging effect.

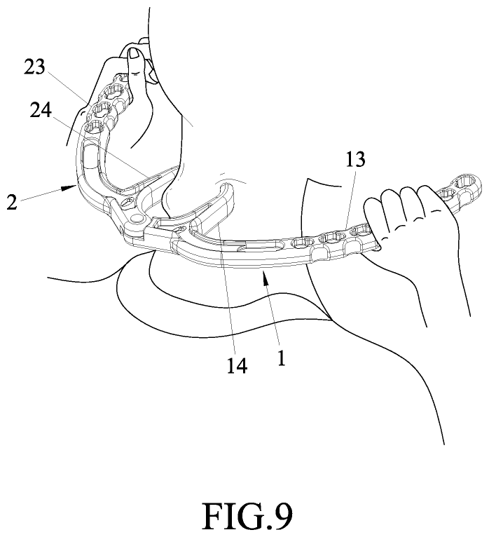

Furthermore, as shown in FIG. 9, this embodiment may be further used to massage the neck. After placing the massage clamp on the rear side of the neck and placing the first pressing portion 13 and the second pressing portion 23 respectively at left and right sides of the neck, forces are applied to the first pressing portion 13 and the second pressing portion 23 so as to clamp the neck muscle by the first clamping portion 14 and the second clamping portion 24, and therefore the neck muscle is massaged and pulled rearwardly, thereby enhancing the massaging effect.

In summary, the massage clamp according to the present disclosure clamps the muscle by the first and second clamping portions 14, 24, and the first and second clamping portions 14, 24 to generate effects of clamping, pushing, pinching, kneading, pressing by operating the first and second clamping members 1, 2. In addition, the muscle may be pulled by moving the massage clamp away from the body of the user, thereby enhancing the massaging effect. Since the force-applying direction and the pulling direction of this disclosure are the same during operation, it is easy to apply the forces during operation, which is ergonomic in design, so that the object of the present disclosure is certainly achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A massage clamp comprising:
a first clamping member having a first pivot portion, a first connecting portion that extends from said first pivot portion, a first pressing portion that extends from said first connecting portion, and a first clamping portion that extends from said first connecting portion; and
a second clamping member pivotally connected to said first clamping member and pivotable relative to said first clamping member, said second clamping member having a second pivot portion that is pivotally connected to said first pivot portion, a second connecting portion that extends from said second pivot portion, a second pressing portion that extends from said second connecting portion, and a second clamping portion that extends from said second connecting portion, said second pressing portion and said first pressing portion cooperatively defining a surrounding space, said second clamping portion and said first clamping portion cooperatively defining a clamping opening, said clamping opening being located in said surrounding space, said first connecting portion, said first pressing portion and said first clamping portion cooperatively forming a Y-shape, said second connecting portion, said second pressing portion and said second clamping portion cooperatively forming a Y-shape, said first clamping portion having a first inner surface that extends to said first connecting portion, said second clamping portion having a second inner surface that extends to said second connecting portion.

2. The massage clamp as claimed in claim 1, wherein said first pivot portion and said second pivot portion are pivoted to each other by a pivot rod, a baseline that is parallel to a first direction and that extends through said pivot rod being defined, said first clamping member and said second clamping member being substantially located at a same side of said baseline.

3. The massage clamp as claimed in claim 2, wherein said first clamping portion terminates at a first distal end, and said second clamping portion terminates at a second distal end, when said first pressing portion and said second pressing portion are operated to move towards each other, said second distal end and said first distal end moving toward each other.

4. The massage clamp as claimed in claim 3, wherein said first pressing portion terminates at a first free end, a distance between said first distal end and a center of said pivot rod in a second direction that is substantially perpendicular to the first direction being smaller than a distance between said first free end and said first distal end in the second direction.

5. The massage clamp as claimed in claim 4, wherein said pivot rod is substantially located higher than said first connecting portion and said second connecting portion in the second direction.

6. The massage clamp as claimed in claim 1, wherein said first connecting portion has a first concave region connected to said first pivot portion, and a first convex region connected to said first concave region, said second connecting portion having a second concave region that is connected to said second pivot portion and that faces said first concave region, and a second convex region that is connected to said second concave region, said second concave region and said first concave region being stacked on each other.

7. The massage clamp as claimed in claim 1, wherein said first pressing portion has a first middle section connected to said first connecting portion, said first middle section having a first concave surface that is recessed outwardly, and a first convex surface that is opposite to said first concave surface, each of said first concave surface and said first convex surface being formed with a plurality of spaced-apart first finger grooves, said second pressing portion having a second middle section that is connected to said second connecting portion, said second middle section having a second concave surface that is recessed outwardly, and a second convex surface that is opposite to said second concave surface, each of said second concave surface and said second convex surface being formed with a plurality of spaced-apart second finger grooves.

8. The massage clamp as claimed in claim 1, wherein said first pressing portion has a plurality of spaced-apart first blind holes, and said second pressing portion has a plurality of spaced-apart second blind holes.

9. The massage clamp as claimed in claim 1, wherein said first clamping member and said second clamping member are substantially symmetrical.
